(19) United States
(12) Patent Application Publication
(10) Pub. No.: US 2010/0193490 A1
(43) Pub. Date: Aug. 5, 2010

(54) Inert gas welding nozzle

(76) Inventor: William Louis Arter, Prineville, OR (US)

Correspondence Address: Thomas M. Spear, Jr., P.O. Box 1274, Bend, OR, 97709-1274, US

(21) Appl. No.: 12/322,291

(22) Filed: Feb. 2, 2009

(51) Int. Cl. B23K 9/00

(52) U.S. Cl. 219/136

(57) ABSTRACT

An inert gas welding torch comprising; a torch body, a collet, an electrode, a nozzle, the nozzle having an upper and lower end, the upper end of the nozzle being connected to the torch body, the collet connected to the torch body and the electrode connected to the collet with the electrode extending through and out the lower end of the nozzle, a path for inert gas starting from a gas supply line and passing through the torch body to the upper end of the nozzle, the gas then passing through at least three gas portals with the gas portals having an inlet and an outlet, the inlet being located at the upper end of the nozzle and the outlet toward the lower end of the nozzle, the portals having substantially uniform dimensions from the inlet to the outlet, wherein the length of the gas portal is at least as long as the longest line that can be drawn across the area of the gas portal inlet.

### CROSS REFERENCE TO RELATED APPLICATION

None

### BACKGROUND OF THE INVENTION

This invention relates generally to inert gas blanketed arc welding and more specifically to a gas shielding welding nozzle (nozzle) that improves the flow characteristic of the shielding gas by increasing laminar flow characteristic of the gas exiting the nozzle. The present invention, by improving the shielding gas flow exiting a welding nozzle, improves the gas blanket covering the weld location during the welding process. This is accomplished by producing laminar flow of the gas. Laminar flow is characterized by the shielding gas (gas) atoms or molecules traveling in the same direction toward the weld as the gas leaves a nozzle outlet. By having the gas all going in the same direction toward the weld, the gas is better able to cover the weld. Gas that is more laminar is less likely to disperse prior to blanketing the weld site. By improving the flow of the shielding gas, it has been observed that using the present invention reduces the amount of shielding gas consumed while providing the same or improved shielding protection of current designs.

Inert gas shielded arc welding has been around for some time with a number of innovations for improving the efficiency of the process. The present invention relates to improvement in the area of gas flow and more particularly to reducing the consumption of inert gas while maintaining a blanket of inert gas covering the weld. The present invention greatly increases the life of the torch components as well. With the gas having a laminar flow, the shielding gas is able to cover the weld site and reduce the amount of oxygen and nitrogen surrounding the weld and therefore improve the strength and durability of the weld.

Shielding gas that has laminar flow when exiting the nozzle is more capable of covering or shielding the arc location from oxygen and nitrogen in the atmosphere and providing for a better weld—by eliminating or minimizing oxygen and nitrogen around the weld site, the weld is stronger and more durable. By increasing the laminar flow of the shielding gas, an operator could reduce the gas flow of the inert gas for the same amount of coverage of current designs. When gas is turbulent, the gas molecules are characterized by traveling in different directions and therefore less likely to cover the weld or remove oxygen and nitrogen in the atmosphere at the weld site.

Shielding gas has been deployed for decades for improving the welding of certain metals—eliminating oxygen and nitrogen at the weld site reduces the amount of corrosion that occurs at a weld site or increases corrosion resistance of a weld. Additionally, it has been found that the weld strength of the weld is improved with an inert gas blanket upon the weld. Improving the flow of the shielding gas has been part of the prior art of gas welding with the present state of the art incorporating elements of a gas lens. U.S. Pat. No. 3,180,967, Gas Lens Shielded Arc Torch, issued to Hill, discloses a device that deploys “a screen or a series of screens for producing coherent streaming of shielding gas through considerable distances upon exiting from the welding torch.” Screens or series of screen are the preferred method for obtaining a somewhat laminar flow for the shielding gas as the gas exits the nozzle of the welding torch. The screens are used to reduce the amount of turbulence of the inert gas as the gas is discharged from the nozzles. The lens is able to focus the gas molecules in a fairly uniform direction.

Turbulent shielding gas is more prone to dissipate and thereby expose the weld site to oxygen and nitrogen thereby weakening the weld and the surrounding metal. Turbulence in the gas flow indicates a more random movement of the gas molecules. Random movement means the gas is escaping the area that is meant to be covered by the inert gas during the welding process. More gas is required to keep the area around the weld sufficiently covered for a proper weld. Experienced welders prefer a consistent and nearly pure inert environment at the weld site for an improved weld.

At an atomic level, laminar flow is characterized by the atoms or molecules of a fluid moving in generally the same direction. Laminar flow is obtained by directing the flow of the fluid in the same direction. The gas lens patent takes advantage of the relatively small screen holes and the differential pressure of the fluid supply line and the outlet pressure. The differential pressure directs the fluid through the numerous small areas of the screen causing the atoms or molecules of the fluid to go in nearly the same direction by squeezing the atoms or molecules of gas through the screens. With the screen openings on the same plane or parallel to the nozzle outlet, the gas exiting the screens is traveling in a nearly perpendicular direction to the screen plane with most of the gas atoms or molecules traveling in a parallel course toward the nozzle outlet. This directional flow is consistent with laminar flow and is the desired effect for welders.

Other modifications to improve the gas flow for better coverage of the weld site include positioning a porous disc as a substitute for gas lens screens or in addition to the gas lens. U.S. Pat. No. 7,329,826 discloses the use of a porous disc in the nozzle area of the welding torch. The gas flows through the porous disc to cause the gas to have a more or less laminar flow. The patent is more directly focused with the placement of the disc in a location in the nozzle weld for ease of removal and replacement.

This patent also describes the limitation of using a screen in that the screens can become clogged and therefore limits the amount of gas covering the weld site. One of the objectives of the present inventions is to limit or minimize the deficiency associated with weld splatter inhibiting the gas flow over the weld site. Additionally, splatter that is able to reach the nozzle is less likely to obstruct the flow of the gas from the present invention. Instead of the fine screen or porous material, the present invention's flow path is more difficult to cover or obstruct and therefore gas flow is less likely to be inhibited.

### BRIEF SUMMARY OF THE INVENTION

An inert gas welding torch comprising; a torch body, a collet, an electrode, a nozzle, the nozzle having an upper and lower end, the upper end of the nozzle being connected to the torch body, the collet connected to the torch body and the electrode connected to the collet with the electrode extending through and out the lower end of the nozzle, a path for inert gas starting from a gas supply line and passing through the torch body to the upper end of the nozzle, the gas then passing through three or more gas portals with the gas portals having an inlet and an outlet, the inlet being located at the upper end of the nozzle and the outlet toward the lower end of the nozzle, the portals having substantially uniform dimensions from the inlet to the outlet, wherein the length of the gas portal is at least as long as the longest line that can be drawn across the area of the gas portal inlet.

In one embodiment of the invention, the gas portals are integrated with the nozzle piece or with the collet. In another embodiment, the gas portals are integrated with a separate piece called a nozzle insert that fits within the nozzle when the torch is assembled. The material for the gas portals can be made from the same type of material that is used for making nozzles, including; ceramics, steel, quartz, aluminum or other material known those skilled in the art of making inert gas welding torches.

In one of the embodiments of the invention, the length of the gas portal is at least five times the length of the longest line that can be drawn across the area of the gas portal inlet. This provides for the best flow characteristic for the inert gas exiting the nozzle to cover the weld.

In the preferred embodiment, the gas portals are symmetrically arranged around the interior of the nozzle adjacent to the nozzle wall with the electrode passing through the center of the nozzle and out the nozzle outlet. Gas passing through the gas portal inlet is squeezed together and while the gas passes through the gas portal toward the gas portal outlet, the atoms or molecules of gas develop a uniform directional flow. As the gas exits the gas portal outlet, the gas atoms or molecules continue toward the nozzle outlet in a near uniform direction and provide for a gas blanketed shield for the welder.

Uniform dimensions and a minimum length of travel for the inert gas within the gas portal increase the laminar flow and minimize turbulence of the gas exiting the nozzle outlet. It is preferred that the gas portals be unobstructed channels that extend through the nozzle from the upper end toward the nozzle outlet. The walls of the portal will be relatively smooth and free of deformities to improve the flow characteristic for the gas exiting the nozzle.

Like most torches, the electrode passes thorough the nozzle and out the nozzle outlet. In the present invention, the electrode passes through the nozzle in the center and a series of gas portals are arranged around the nozzle allowing for gas to flow from the torch toward the nozzle outlet. The electrode can be set in the nozzle with additional insulative material or the electrode can extend through the nozzle without touching the nozzle material. Current nozzle designs are void of filler material and in the present invention the electrode passes through the nozzle without much surrounding the electrode. The present invention provides for space filling material in which the gas portals are symmetrically arranged around the electrode in the middle.

Gas is typically introduced into the torch after leaving a gas source, like a cylinder of gas, and then passing through a gas regulator and flow meter. The gas upon entering the torch is directed toward the nozzle outlet. The path the gas takes within the torch body can be numerous and generally a more direct path to the upper end of the nozzle is preferred. In the present invention, the gas is able to pass through or around the collet as long as the gas reaches the upper end of the nozzle at which point the gas enters the gas portals and pass through the uniform and unobstructed paths. The molecules of gas attain uniform direction as the gas passes through the portals.

The improved nozzle can be made from any metal or ceramic that can withstand the heat and temperatures associated with arc welding and any material that is currently being used for arc welding nozzles is able to be used in the present invention. The nozzle could be made from a number of materials including; stainless steel, ceramic, aluminum or other material known to those skilled in the art.

Another embodiment of the present invention is to use a nozzle insert that either fits within a nozzle or a nozzle insert that affixes to the end of a collet extending into the nozzle when the torch is assembled. Various means for accomplishing the basic function of placing gas portals of uniform dimension whose length is a function (the longest line drawn across the gas portal opening) of the gas portal opening within the nozzle is claimed.

### BRIEF DESCRIPTION OF SEVERAL VIEWS OF THE DRAWINGS

FIG. 1 is a view of a welding torch, according to an exemplary embodiment of the present invention.

FIG. 2 is an exploded view of the welding torch with a cross sectional view of the upper torch body and collet;

FIG. 3 is a topside view of a nozzle with gas portals symmetrically arranged around the periphery and a space for an electrode to pass through the middle;

FIG. 4 is a length wise cross sectional view of the nozzle displaying two of the gas portals on the periphery of the nozzle near the nozzle wall and an electrode passing through the nozzle.

FIG. 5a is an exploded view of the various torch pieces with a nozzle insert attached to the lower end of the collet.

FIG. 5b is an exploded view of the various torch pieces with a separate nozzle insert that fits inside the nozzle.

### DETAILED DESCRIPTION OF THE INVENTION

Various embodiments of the invention will now be described. The following descriptions provide specific details for a thorough understanding and enabling description of these embodiments. It should be noted, however, that the above “Background” describes technologies that may enable aspects and embodiments of the invention. One skilled in the relevant arts will understand, however, that the invention may be practiced without many of these details. Additionally, some well-known structures or functions may not be shown or described in detail, so as to avoid unnecessarily obscuring the relevant description of the various aspects and embodiments of the invention.

The terminology used in the description presented below is intended to be interpreted in its broadest reasonable manner, even though it is being used in conjunction with a detailed description of certain specific embodiments of the invention. Certain terms may even be emphasized herein; however, any terminology intended to be interpreted in any restricted manner will be overly and specifically defined as such in this Detailed Description section.

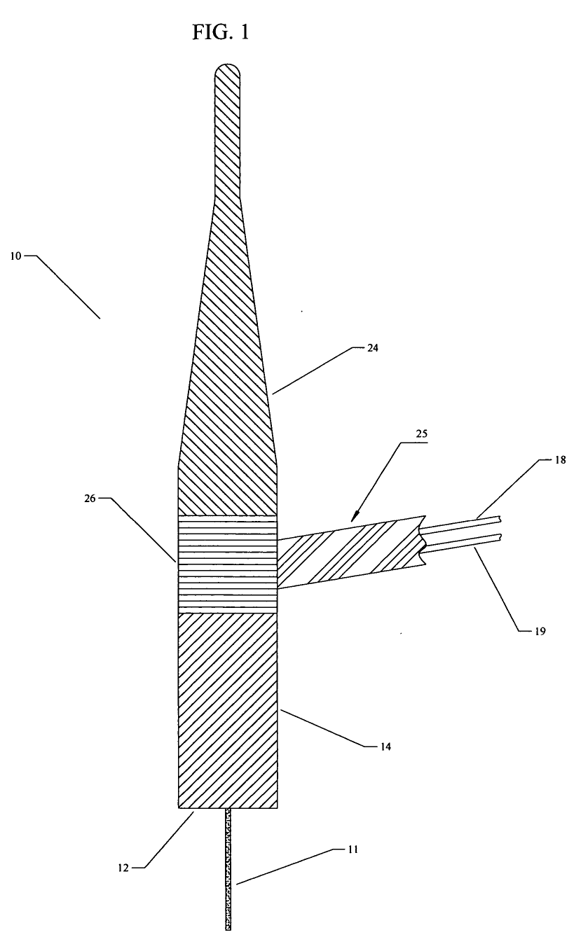

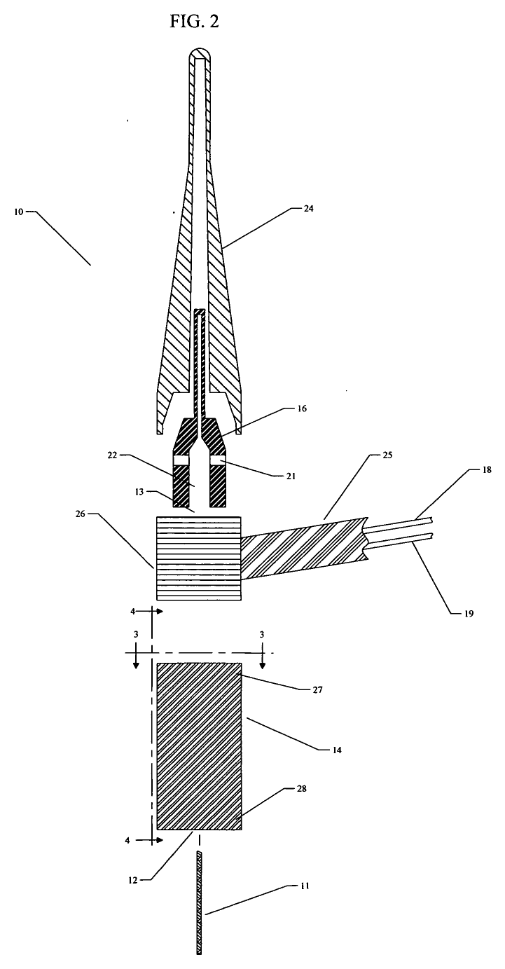

A shielding gas arc welder typically consists of several components, including; a torch, an electrode, a clamp, a power source, and an inert gas supply—typically a cylinder with compressed gas, a regulator, and hoses or leads. The compressed gas and power leads are controlled and regulated outside the torch body. FIG. 1 depicts a typical torch 10 with various components identified in the figure. FIG. 2 is a partially exploded view of the torch in which some of the individual pieces are identified. The components of the torch can come in a variety of models but the components are fairly consistent and provide for similar functions.

In the exploded view, FIG. 2, the torch body consists of three pieces, the upper torch 24 piece, the mid torch piece 26 and a handle 25. Automated welders do not use a handle but the basic concept of passing inert gas through the nozzle to blanket a weld is the same. The concept of the present invention is focused upon the discharge of inert gas exiting a nozzle outlet 12 of the torch 10. In the prior art and in most models of torches, a gas lens (not shown) is deployed in the area or location of an exit aperture 13 of FIG. 2. In the prior art, the gas lens is typically attached to a collet 16. The collet 16 provides a means for connecting an electrode 11 to the torch 10. The collet 16 is insulated from the rest of the torch 10 to prevent a welder from receiving an electric shock during welding.

The collet 16 can be attached or connected to the upper torch piece 24 or the mid torch piece 26. At the lower end of the collet 16 is the area of the exit aperture 13 and for the purposes of describing the present invention the place inert gas ends up prior to discharging out the nozzle outlet 12. The exit aperture 13 in FIG. 2 is located near the lower end of a mid torch piece 26 when the torch is assembled. In the configuration shown in FIGS. 1 and 2, the handle 25 is connected to the mid torch piece and a gas line 18 and power line 19 run to the torch 10 through the handle 25. Other arrangements for delivering power and inert gas to the torch are available and known to those skilled in the art and the description and figures with respect to power and inert gas delivery to the torch 10 are not meant to limit the scope of the claims.

To best describe the present invention, a description of the gas traveling from the cylinder through the torch will be discussed. Inert gas is provided by a pressurized bottle (not shown) with regulators (not shown) that are controlled by a welder. Gas flow regulator systems are numerous and not a part of the present invention. Gas flow is set by the welder to provide sufficient coverage of inert gas over a weld during the welding process. After the proper flow is determined by the welder, that is usually read on gas flow meter (not shown), the gas travels through a gas line 18 toward the torch 10. Once the gas enters the torch 10 through the mid torch piece, the gas is directed toward the nozzle outlet 12.

The specific path that the gas follows upon entering the mid torch piece 26 can be varied. The present invention provides for various gas paths to be configured within the torch. In the prior art, gas is typically passed through the torch 10 by passing through the collet 16 toward the nozzle outlet 12. In the prior art, the gas lens would be affixed at the lower end of the collet 16 in the area of the exit aperture 13 toward the nozzle. In the present invention, the path the gas takes to travel to an upper end of the nozzle 27 is not meant to be limited and references to inert gas traveling toward or being discharged in the area of the exit aperture 13 is intended to facilitate the description of the present invention.

It is preferred that, whatever path is used from the mid torch piece 26 to the area of the exit aperture 13, a straighter and less obstructed path be used to reduce the amount of turbulence the gas undergoes once the gas enters the torch 10. When gas is communicated to the area of the exit aperture 13, the gas will then proceed through the nozzle 14 to the lower end of the nozzle 28 and out the nozzle outlet 12.

The pressure differential of the regulated gas in the line 18 and the atmospheric pressure at the nozzle outlet 12 causes the gas to flow from the gas line 18 through the torch body 10 and out the nozzle outlet 12. The direction of the gas flow exiting the nozzle outlet 12 is generally perpendicular to the plane of the nozzle outlet 12. Gas exiting the nozzle outlet 12 is meant to cover the weld site and replace and minimize oxygen and nitrogen in the atmosphere at the weld site during the welding process to improve and strengthen the weld. Oxygen and nitrogen molecules at the weld site during welding process decrease the strength of the weld and increase the likelihood for corrosion.

In the prior art a gas lens could be deployed to improve the flow characteristic of the inert gas covering the weld. A gas lens is a series of screens deployed in the path of the inert gas near the exit aperture 13 prior to the gas exiting the nozzle outlet 12. The screens are placed in the path of the gas and cause the gas to stream in a near uniform direction. When the gas molecules are moving in the same direction, the gas has a laminar flow. Smoke test of gas lenses and experience with inert gas welding has demonstrated that the laminar flowing gas covers a weld more effectively than gas that is more turbulent when the gas is exiting the nozzle outlet. When the gas is laminar, the gas molecules are more readily able to eliminate or replace the oxygen and nitrogen of the surrounding atmosphere.

The best coverage of inert gas, as observed during smoke tests, has been demonstrated when the weld site is exposed to inert gas in which the gas is flowing in the same direction. This means that gas leaving the nozzle outlet 12 with most of the gas molecules moving in the same direction will provide better coverage of the weld site and remove or exclude more oxygen and nitrogen. When the gas is not flowing in the same direction the gas would be considered turbulent. Turbulent flow is more consistent with gas having a less directional flow. When the gas is turbulent, the gas molecules are escaping from the gas flow and it is more likely that fewer gas molecules will reach the weld site and thereby lessening the ability of the inert gas to remove and replace the oxygen and nitrogen at the weld.

In the present invention, gas entering the handle 25 through the gas line 18 enters the mid torch piece 26. Gas is directed through inner apertures 21 in the collet 16 allowing the gas to travel down an inner chamber 22 toward the exit aperture 13 area. When the torch 10 is assembled, the exit aperture 13 is located at the lower end of the collet 16 and above an upper end of the nozzle 27. Other flow paths can be used for getting the gas toward the area of the exit aperture 13 in the torch body.

As gas flows out of the collet 16 in the area of the exit aperture 13, the gas continues to travel toward the nozzle outlet 12 due to the pressure differential of the gas and the surrounding atmosphere. In the prior art, the gas would travel through the nozzle 14 and out the nozzle outlet 12 toward the weld site. The nozzle is typically a cylindrical shaped housing in which the electrode 11 extends from the torch 10 and out the nozzle outlet 12.

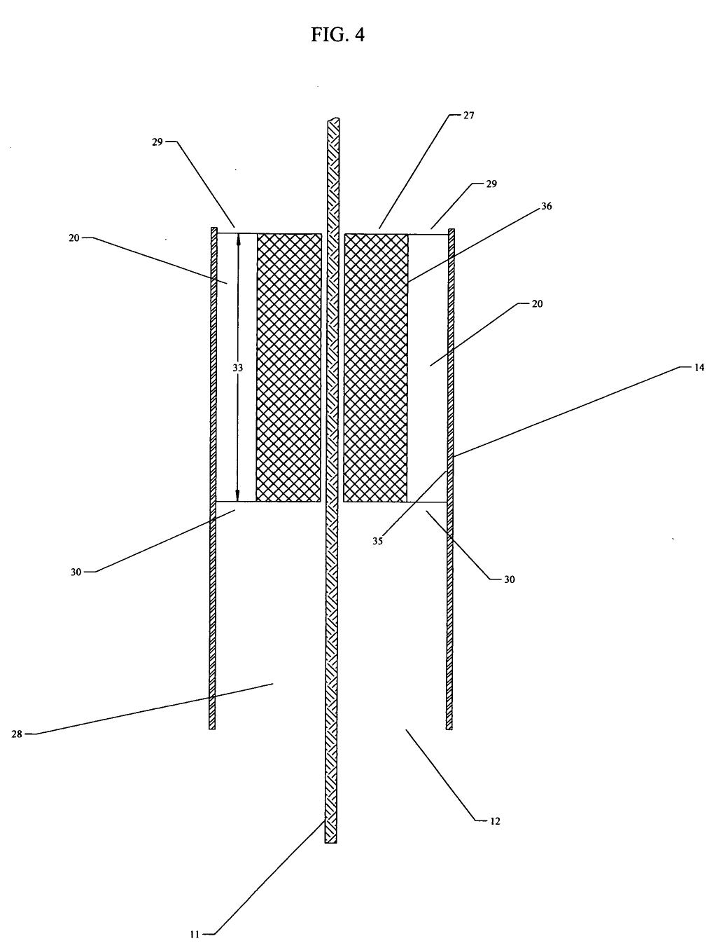

In the present invention, as the gas reaches the exit aperture 13 the gas travels from an upper end 27 of the nozzle toward a lower end 28 of the nozzle 14, see FIG. 2 and FIG. 4. Within the nozzle 14 toward the upper end of the nozzle 27 are three or more gas portals 20 in which the gas passes through prior to exiting the nozzle outlet 12. The upper end 27 of the nozzle 14 attaches to the mid torch piece 26 facilitating the passing of the inert gas through the three or more gas portals 20 within the nozzle 14.

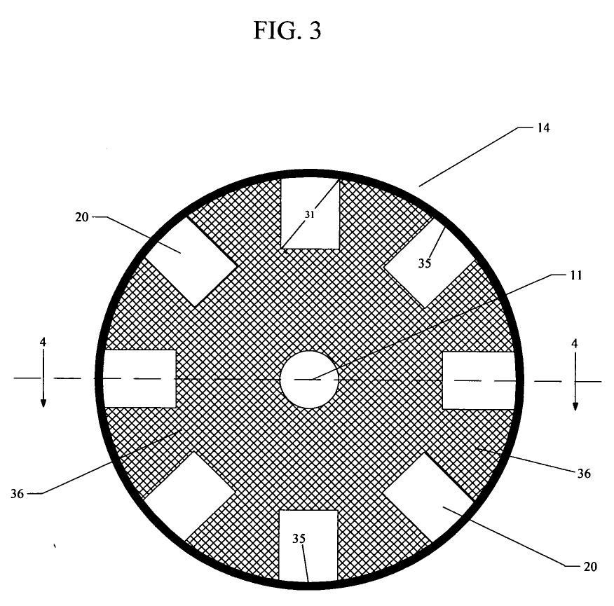

In the embodiment presented in FIGS. 3 and 4, the gas portals 20 are symmetrically arranged around a periphery of an inner wall 35 of the nozzle. In one of the preferred arrangements for the gas portals, as in FIG. 3, there are eight gas portals 20 arranged around the periphery of the inside of the nozzle 14. The walls of the gas portals 20 are formed from the inner wall 35 of the nozzle and from a solid piece 36 located within the nozzle 14. The gas portals 20 are created from the solid piece 36 by either molding, forming, extruding, cutting, or other means known to those skilled in the art. The material can be made from stainless steel, steel, aluminum, ceramic, or other material known to those skilled in the art of manufacturing welders. The solid piece 36 can either be made from the same material as the nozzle or be part of the nozzle.

For the gas portals 20 as depicted in FIG. 3 and FIG. 4, the gas passes from the area of the exit aperture (from FIG. 2) through the gas portals 20 at the upper end 27 of the nozzle 14 and passes out the lower end 28 of the nozzle 14 and out the nozzle outlet 12, see FIG. 4. The dimensions or area of the gas portals 20 is uniform from a gas portal inlet 29 through a gas portal outlet 30. By maintaining uniform dimensions throughout the gas portal 20, the gas is able to achieve a more uniform directional flow and increase the laminar flow characteristic of the gas. When the gas exits the gas portals outlet 30, the gas is directed toward the nozzle outlet 12 toward the weld site to cover the weld.

The gas portals 20 communicate the gas from the exit aperture 13 to the nozzle outlet 12. When the gas enters the gas portal inlets 29, the gas molecules are constricted for a length 33 of the gas portal 20. It has been demonstrated that the longer the length 33 of the gas portal, the more uniform the flow of the gas exiting the gas portal outlet 30. By having increased laminar flow characteristic, the gas is better able to cover the weld site at a longer distance from the nozzle outlet and this allows the welder to extend the electrode 11 further from the torch 10 and provides the welder with a better view of the weld site during the welding process.

The gas portal inlets have a relatively small area opening compared with the length 33 of the gas portals 20 depicted in FIG. 4. The dimensions of the walls of the gas portal are uniform from the gas portal inlet 29 to the gas portal outlet 30.

In the preferred embodiment, the gas portal 20 dimensions will be such that the area opening at the inlet 29 of the gas portal will be the same or uniform from top to bottom. The area of the gas portal opening will be such that a longest line 31 that can be made within the area of the gas portal inlet 29 will be the minimum length 33 of the gas portal 20. In the preferred embodiment, the gas portal length 33 will be at least five times the length of longest line 31 that can be drawn across the area of the gas portal inlet 29 opening. This ensures that the gas will have little or no turbulent flow characteristic when the gas exits the nozzle outlet 12.

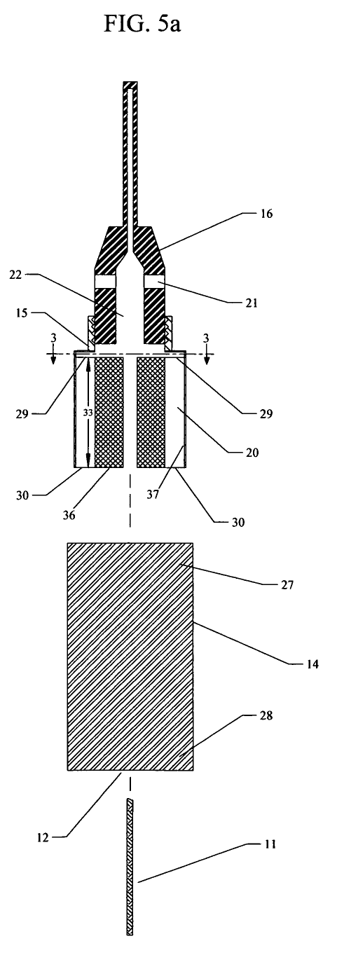

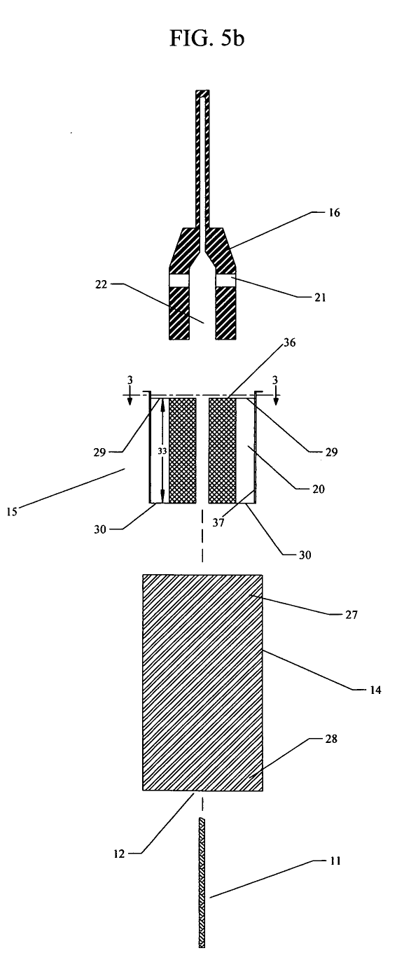

In another embodiment of the present invention, a nozzle insert 15 can be placed inside a nozzle 14 or attached to the lower end of the collet, see FIGS. 5a and 5b. The nozzle insert is a separate device that performs the same function of the previously described embodiment-directing the inert gas toward the nozzle outlet 12 in a uniform direction through gas portals 20 located inside the nozzle 14.

When the nozzle insert 15 is attached to the lower end of the collet 16, FIG. 5a, the inert gas as it passes through the inner aperture 21 and flows down the inner chamber 22 will be directed to pass through the gas portals 20 of the nozzle insert 15. There is no exit aperture 13 when the nozzle insert 15 is attached to the collet. This embodiment envisions the collet 16 being integrated with the nozzle insert 15. The gas portal design and description are the same as previously described and shown in FIG. 3 with the inert gas entering the gas portal 20 at a gas portal inlet 29 and exiting out the lower end of the nozzle insert 15 at the gas portal outlets 30. An outer wall 37 of the gas portal 20 is the outer wall of the nozzle insert 15. When the torch is assembled as in FIG. 1, the nozzle insert will fit into the inside of the nozzle 14 similar to the previous embodiment.

The gas portals 20 of the nozzle insert 15 have uniform dimension from the gas portal inlet 29 to the gas portal outlet 30. The nozzle insert 15 can be attached as a separate piece to the collet 16 or can be an integrated piece with the collet 16. In the preferred embodiment, the length 33 of the gas portals 20 of the nozzle insert 15 are at least five times the length of the longest line 31 that can be drawn across the area of the gas portal inlet 29, see FIG. 3 and FIG. 5a.

Another benefit that the present invention overcomes is the interruption of gas flow from the nozzle outlet due to weld spatter hitting the gas lens. It is not uncommon for weld spatter to clog or contaminate the gas lens screens. Spatter is generated by the welding process when the arc from the torch touches the welding spot on the metal to be welded. The spatter consists of tiny pieces of metal that is liquefied and then spattered away from the weld site. Occasionally, the spatter will go in the direction of the nozzle outlet and contaminate the interior of the nozzle and thereby the gas lens screens. The gas lens is made of one or more layers of very fine wire screen which tend to melt and fuse to spatter particles which are globs of molten metal expelled from the weld puddle.

The gas portals 20 of the present invention are more difficult to clog or damage than screens and any spatter that does land on the interior of the nozzle can be more easily removed without damaging the gas portals. The individual gas portal area openings are larger than the individual screen openings and the spatter is less likely to clog or interrupt the flow of the gas that passes through the gas portals.

The welder can adjust the amount of gas used depending on the distance from the nozzle outlet that the electrode is extended. The further the electrode is extended from the nozzle outlet the more gas is required to cover the weld. By using gas portals within the nozzle or a nozzle insert provides for an increased laminar flow for the same amount of gas passed from the nozzle outlet. By decreasing the supply of the gas, the present invention provides for improved gas coverage of the weld area with less gas consumption.

The use of gas portals in the gas flow paths through the nozzle in the present invention requires a restriction of the flow of the gas through the torch body and out the nozzle outlet. By restricting the area in which gas is able to be delivered through the torch reduces the amount of gas that is ultimately discharged when the pressure at the discharge of the regulator is constant. A welder is concerned with the amount of gas discharged from the nozzle outlet and the flow characteristic of the gas. The welder will set the flow rate to ensure the weld site is adequately shielded by the inert gas. By introducing gas portals through the gas flow path, the flow rate of the gas is reduced by the proportional the cross sectional area of the gas portals divided by the cross sectional area of the gas portal and the filler material in which the gas portals are created from. The concept of reduced flow rates for the same shielding coverage is one of the benefits of using gas portals for obtaining laminar flowing gas.

The material with which the gas portals or nozzle insert can be made from include, ceramic, aluminum, steel—preferably stainless steel or any hard metal that is able to withstand temperatures associated with welding torches. The gas portals can be integrated with the nozzle, a separate nozzle insert or part of the collet. In the present invention, little discussion or detail has been directed toward the path the inert gas travels from the handle and within the mid torch piece 26. The embodiments disclosed are not meant to limit the nature of the claims in that the present invention is directed toward creating uniform directional flow of inert gas by passing the gas through gas portals that are at least as long as the longest line that can be drawn across the area of the gas portal inlet.

When the gas exits the nozzle outlet, the laminar flowing gas is moving perpendicular to the nozzle outlet and blanketing the weld. The atoms or molecules of turbulent gas exiting from the nozzle outlet would be moving in a more random fashion and less likely to replace and remove oxygen and nitrogen from the weld.

Another embodiment claimed for obtaining laminar flowing gas for the inert shielded arc welder is to deploy gas portals that have a tapering dimension from the inlet to the outlet of the gas portal. This embodiment takes advantage of the concept of a high velocity flow nozzle in which the gas portal dimension become convergent from the inlet to the outlet of the gas portal. Acting like a convergent nozzle, the inert gas atoms or molecules increase in velocity as they approach the outlet of the gas portal. By increasing the velocity of the gas, the gas is able to reach and shield welds that are further from the nozzle outlet.

I claim:

1. An inert gas welding torch comprising;
a torch body, a collet, an electrode, a nozzle,
the nozzle having an upper and lower end, the upper end of the nozzle being connected to the torch body,
the collet connected to the torch body and the electrode connected to the collet with the electrode extending through and out the lower end of the nozzle,
a path for inert gas starting from a gas supply and passing through the torch body to the upper end of the nozzle, the gas then passing through at least three gas portals with the gas portals having an inlet and an outlet, the inlet being located at the upper end of the nozzle and the outlet toward the lower end of the nozzle, the portals having substantially uniform dimensions from the inlet to the outlet, wherein the length of the gas portal is at least as long as the longest line that can be drawn across the area of the gas portal inlet.

2. The torch of claim 1 wherein the gas portals are integrated with the nozzle.

3. The torch of claim 1 further comprising a nozzle insert, wherein said nozzle insert is a separate piece from said nozzle and fits within the nozzle and the inert gas passes through gas portals within the nozzle insert.

4. The torch of claim 1 wherein the gas portals are integrated with the collet.

5. The torch of claim 1 wherein the length of the gas portals is at least five times the length of the longest line that can be drawn across the area of the gas portal inlet.

6. The torch of claim 1 wherein the path through the gas portals is parallel to the length of the electrode from the collet to a nozzle outlet.

7. The torch of claim 1 wherein the path of the inert gas passes through eight gas portals symmetrically arranged around an interior wall of the nozzle.

8. A welding torch for improving gas shielding flow to a weld comprising;
a torch body,
a gas supply connected to the torch body,
a nozzle piece,
the nozzle piece having an upper end and a lower end with the upper end connected to the torch,
at least one gas flow path from said gas supply line through the torch body to an area above the upper end of the nozzle piece,
at least three gas portals conducting the gas from the upper end of the nozzle piece toward the lower end of the nozzle piece, and
the gas portals having an inlet at the upper end of the nozzle and an outlet toward the lower end of the nozzle, wherein the gas portals are uniformly dimensioned from the inlet to the outlet and the length of the gas portals as measured from the inlet to the outlet is at least the length of the longest line that can be drawn across the area of the gas inlet opening.

9. The torch of claim 8 wherein the gas portals are integrated with the nozzle piece.

10. The torch of claim 8 further comprising a nozzle insert, wherein said nozzle insert is a separate piece from said nozzle piece and fits within the nozzle and the inert gas passes through gas portals within the nozzle insert.

11. The torch of claim 8 wherein the length of the gas portals is at least five times the length of the longest line that can be drawn across the area of the gas portal inlet.

12. The torch of claim 8 wherein the path through the gas portals run parallel to the electrode.

13. The torch of claim 8 wherein the path of the inert gas passes through eight gas portals symmetrically arranged around an interior wall of the nozzle.

14. The torch of claim 1 wherein the gas portal dimensions from the inlet to the outlet are convergent.

15. The torch of claim 8 wherein the gas portals dimensions from the inlet to the outlet are convergent.

16. The torch of claim 1 wherein the gas portal dimensions from the inlet to the outlet are divergent.

17. The torch of claim 8 wherein the gas portal dimensions from the inlet to the outlet are divergent.
